(19) United States
(12) Patent Application Publication
(10) Pub. No.: US 2017/0008776 A1
(43) Pub. Date: Jan. 12, 2017

(54) FACILITY AND METHOD FOR TREATING WATER PUMPED IN A NATURAL ENVIRONMENT BY EVAPORATION/CONDENSATION

(71) Applicant: STARKLAB, Nomain (FR)

(72) Inventor: JAOUAD ZEMMOURI, NOMAIN (FR)

(21) Appl. No.: 15/113,401

(22) PCT Filed: Jan. 22, 2015
(86) PCT No.: PCT/FR2015/050155

§ 371 Date: Jul. 21, 2016

(30) Foreign Application Priority Data
Jan. 24, 2014 (FR) 1450612

(51) Int. Cl. C02F 1/10; F01K 11/02; B01D 3/34; C02F 1/06; B01D 1/14; B01D 3/00

(52) U.S. Cl. CPC C02F 1/10; B01D 1/14; B01D 3/007; B01D 3/346; C02F 1/06; F01K 11/02; C02F 2103/007

(57) ABSTRACT

The invention relates to a facility which comprises an evaporation device (1′), which comprises an evaporation chamber (10) intended for containing water (11) in liquid form and allowing only a portion of the water contained in the evaporation chamber (10) to be evaporated, and gas-supply means (12) for injecting a gas into the water (11) contained in the evaporation chamber (10), such as to form gas bubbles in said water, and a heat exchanger (3), which comprises cooling means (300, 310, 311/300, 301) and which allows at least the water vapour from the evaporation chamber (10) to be condensed. The facility comprises water-supply means (14), which make it possible to pump water in liquid form (L) in a natural environment, to send said water pumped in a natural environment through said cooling means (300, 310, 311/300, 301) or to bring said water into contact with said cooling means (300, 310, 311/300, 301), such as to allow the cooling of the water vapour from the evaporation chamber (10), and to supply the evaporation chamber (10) with said water after said water has been heated, having passed through or been brought into contact with said cooling means (300, 310, 311/300, 301). The evaporation chamber (10) comprises means (10c; 143) for discharging a portion of the water in liquid form (L) contained in the chamber which, in combination with the water-supply means (14), make it possible to renew the water inside the chamber such that the temperature of the water contained in the chamber (10) is kept at a temperature that is sufficient for maintaining the evaporation of a portion of the water contained in the evaporation chamber (10).

### TECHNICAL FIELD

The present invention relates to a new facility and a new method for treating water pumped in liquid form in a natural environment by evaporation/condensation, in particular such as seawater, lake water or water from a stream, or groundwater. The invention for example makes it possible to desalinate seawater, or to purify water pumped in a natural environment. The invention is also applicable to the use of the thermal energy of water pumped in a natural environment to produce electricity or to treat a gas.

### PRIOR ART

At normal atmospheric pressure (at sea level), water evaporation occurs around 100° C. This evaporation occurs when the outside environment supplies energy to the water having become steam in the form of latent heat Lᵥ. As long as the water stays in its steam state, this energy Lᵥ remains stored in said steam. If the temperature of the steam is decreased, one then witnesses the condensation phenomenon whereby the steam turns into liquid while ceding its stored energy to the outside environment.

The passage from liquid to gaseous state is often referred to indifferently as evaporation and boiling. In reality, these two phenomena are different and appear under different circumstances. Evaporation refers to the appearance of molecules in gaseous state at the surface of the liquid. If energy is supplied quickly at the bottom of the container, the temperature increases gradually over the entire water column, but at the surface in contact with the energy supply, the temperature will quickly exceed the evaporation temperature (100° C. for water at a normal atmospheric pressure). This creates a local evaporation in the form of small bubbles in the water that will escape and rise in the liquid due to the buoyancy. This phenomenon will accelerate with the increase in the temperature of the liquid and the number of bubbles becomes high; the boiling phenomenon is then obtained. Boiling may be said to be three-dimensional or volume-based evaporation, unlike the traditional evaporation that takes place on the surface.

The evaporation of a liquid, and in particular low-pressure water, is also a well-known and controlled method. This evaporation method is related to the fact that the evaporation temperature of a liquid, and in particular of water, decreases with atmospheric pressure above that liquid. For example, at 0.2 bar, the evaporation temperature of water is approximately 60° C.; at 20 mbar, the evaporation temperature of water is approximately 17.5° C. Thus, if one for example places water at 20° C. in a container, for example a beaker, in the short term, nothing happens at atmospheric pressure. If the container is placed in a vacuum chamber connected to a vacuum pump, the water begins to boil abruptly, and the temperature of the water decreases more and more, ultimately finishing at a temperature below zero. After a certain time, the remaining water ends up freezing, thus ending the evaporation. It is therefore possible, by decreasing the pressure sufficiently, to cause water to evaporate and boil at a low temperature, and for example at 20° C.

When a liquid like water evaporates, it needs energy to go from the liquid phase to the gaseous phase: this is the latent heat Lᵥ. The latent heat Lᵥ is equal to 2.25 MJ/kg for water at atmospheric pressure. This energy is supplied by the volume of water in liquid state that does not evaporate and by the container containing the water in liquid state, which supply this thermal energy by decreasing their temperatures. As long as the evaporation continues, the temperature continues to decrease until it drops below 0° C. and the liquid water ends up turning into ice. If the participation of the container is set aside, as a first approximation, it may be considered that the energy is kept between the energy received by the evaporated water and the energy supplied by the liquid water. Eₑᵥₐ=E_{liq} where Eₑᵥₐ is the energy received by the evaporated water and E_{liq} is the energy supplied by the liquid water.

E_{liq}=m_{liq}C_{pliq}ΔT

where m_{liq} is the mass of non-evaporated liquid, C_{pliq} is the heat capacity of the liquid and is equal to 4.18 kJ/kg/K for water and ΔT is the variation of the temperature of the liquid water.

Eₑᵥₐ=mₑᵥₐLᵥ

where mₑᵥₐ is the mass of evaporated liquid and Lᵥ is the latent heat and is equal to 2.25 MJ/kg for the water at atmospheric pressure.

The conservation of the energy and the material requires that Eₑᵥₐ=E_{liq}, therefore

mₑᵥₐLᵥ=m_{liq}C_{pliq}ΔT

It is this relationship (Eₑᵥₐ=E_{liq}) that makes it possible to extract energy from a liquid by evaporation, and for example to extract energy by evaporation from water pumped in a natural environment, in particular seawater, lake water or water from a stream.

This phenomenon of evaporation of a liquid, and in particular water, at low pressure, has been used for many years to produce steam and to use the produced steam to generate electricity.

This electricity produced from steam can be obtained using a turbine, for example as in French patent applications FR 2,515,727 and FR 2,534,293.

This electricity can also advantageously be produced by condensing steam, and in particular produced water vapor, and by converting the energy recovered during the condensation of the steam into electricity.

More particularly, over the last decade, the conversion of thermal energy from oceans and seas has made considerable progress with OTEC (Ocean Thermal Energy Conversion) technology. OTEC systems are for example described in international patent applications WO 81/02231, WO 95/28567 and WO 96/411079 and in patent U.S. Pat. No. 3,967,449, and convert the thermal energy into electricity by using the temperature difference between the hot seawater on the surface and the cold seawater at greater depths.

Usually, closed-cycle OTEC systems are used that use a thermodynamic cycle of an intermediate working fluid. To that end, three types of thermodynamic cycles exist, namely Rankine, Kalina and Uehara, that are compatible with the principle of the OTEC systems.

### Rankine Cycle:

This cycle is used with organic liquids that have a boiling point lower than that of water. It is consequently called “Organic Rankine Cycle” (ORC).

### Kalina Cycle:

http://www.thermoptim.org/sections/technologies/systems/cycle-kalina/
This cycle uses a mixture of water and ammonia as working fluid. The ammonia concentration is variable depending on the need of each step of the cycle. In theory, the effectiveness is 20% higher than that of the ORC cycle. The working fluid (water+ammonia) is boiled using the heat released by the hot source. Next, the fluid penetrates a separator and splits in two:
the vapor phase with a high ammonia concentration that subsequently enters the expansion turbine, which causes the electricity generator to turn.
the liquid phase with a low concentration is used in the regenerator. The two flows are subsequently merged in the condenser, where the fluid condenses while giving heat to the cold source. The fluid at the outlet of the condenser is preheated in the regenerator, and the same cycle starts again.

The Kalina cycle has the particularity of varying the concentrations of heat transfer fluid (water+ammonia) in order to change the operating points. Indeed, at the exchanger, the ammonia concentration is high, which makes the evaporation temperature low. It is thus possible to evaporate the fluid at a lower temperature. If the ammonia concentration is low, this makes the condensation temperature higher and it therefore becomes easier to condense the steam, since the liquid that will be used to condense (cold source) will not need to be very cold.

### Uehara Cycle:

http:/www.thermoptim.org/sections/technologies/systemes/cycle-uehara
This cycle also uses water and ammonia as the working fluid with a fixed ammonia concentration, but its theoretical effectiveness is greater than Kalina, and this cycle is above all suitable for hot source temperatures between 20 and 30° C.

This electricity production cycle using thermal energy from the sea is an improvement on the Kalina cycle. Its main particularity lies in simplifying the composition change of the water-ammonia mixture by using a staged expansion with withdrawal.

Just like for the Kalina cycle, the interest of this cycle lies in replacing the evaporations and condensations with a constant working fluid temperature with evolutions using a sliding temperature, and therefore reducing the irreversibility of the system.

In this cycle, an ammonia-rich mixture is heated in an economizer and a vaporizer, which it leaves in its diphasic state. The vapor and liquid phases are then separated, the first being expanded to an intermediate pressure in a turbine.

Part of this expanded flow is recirculated at medium pressure, then cooled by exchange with the base mixture, with which it is mixed, to form the working fluid, which is next brought back to pressure.

The main flow leaving the turbine is expanded to the low pressure in a second turbine, then oriented toward an absorber, where it is mixed with the liquid fraction leaving the separator and cooled beforehand in the regenerator by exchange with the working fluid leaving the rich pump, then expanded to the low pressure. Upon leaving the absorber, the obtained base mixture is condensed before being compressed at the intermediate pressure.

In practice, a 100-MW OTEC facility operating with a Uehara cycle has the following characteristics:
Net electric power: 64 MW
Daily electricity production of 1.5 GWh
Annual electricity production of 514 GWh
Daily fresh water production: 120,000 m³/day
Hot seawater flow rate: 111 m³/s (=111,111 kg/s)
Cold seawater flow rate: 111 m³/s (111,111 kg/s)
Electricity need (generally for the pumps): 23 MW.
   The major drawbacks of the OTEC systems, and in particular of OTEC systems based on the Uehara cycle, are:
the very high intake flow rates of hot and cold seawater and their potential effects on the environment.
the aspiration of water at a great depth (generally 1000 meters) for the condenser, which greatly reduces the yield of the system.

Water desalination systems have also been proposed implementing a humidifier (evaporation device) coupled to a dehumidifier (condensation device). These systems are for example described in the publication “A solar desalination system using humidification-deshumidification process—A review of recent research,” Y B Karhe et al., International Journal of modern Engineering Research, pages 966-977, Apr. 30, 2013. In these water desalination systems, the evaporation of the water in the evaporation device is obtained owing to prior heating of the water before it is introduced into the evaporation chamber, in particular by using solar energy, and all of the saltwater introduced into the evaporation device is evaporated, so as to subsequently recover the brine in the bottom of the evaporation device. These water desalination systems do not make it possible to work with high water flow rates, and it is not conceivable for these systems to use the small quantity of water vapor generated to produce electricity.

### AIM OF THE INVENTION

The invention aims to propose a new technical solution for treating water in liquid form pumped in a natural environment by evaporation/condensation, in particular such as seawater, lake water or water from a stream, or groundwater. The solution according to the invention makes it possible to improve the energy conversion yields and the implementation costs.

### BRIEF DESCRIPTION OF THE INVENTION

The first object of the invention is thus a facility for treating water pumped in a natural environment by evaporation and condensation. Said facility includes an evaporation device, which comprises an evaporation chamber intended to contain water in liquid form, and allowing only a portion of the water contained in the evaporation chamber to be evaporated, and gas supply means making it possible to inject a gas into the water in liquid form contained in the evaporation chamber, so as to form gas bubbles in that water. Said facility further includes a heat exchanger, which includes cooling means and which makes it possible at least to condense the water vapor coming from the evaporation chamber. Said facility comprises water supply means, which make it possible to pump water in liquid form in a natural environment, and in particular seawater, lake water or water from a stream, or groundwater, to send said water in liquid form pumped in a natural environment through said cooling means or place it in contact with said cooling means, so as to allow the cooling of the water vapor coming from the evaporation chamber, and to supply the evaporation chamber with that water in liquid form pumped in a natural environment after that water in liquid form has been heated while having traversed or been placed in contact with said cooling means. The evaporation chamber includes means for discharging part of the water in liquid form contained in the chamber which, in combination with the water supply means, allow a renewal of the water in liquid form inside the chamber such that the temperature of the water in liquid form contained in the chamber is kept at a sufficient temperature to maintain the evaporation of part of the water contained in the evaporation chamber.

More particularly, the facility according to the invention may include the following additional and optional features, considered alone or in combination with one another:
The evaporation chamber has no additional means for heating the water contained in the evaporation chamber.
The facility has no additional means for heating the water between the cooling means and the evaporation chamber.
Said cooling means of the heat exchanger are positioned outside the evaporation chamber, and the water supply means make it possible to circulate said water in liquid form pumped in a natural environment through said cooling means of the heat exchanger, and make it possible to supply the evaporation chamber with said water in liquid form pumped in a natural environment, after it passes through the cooling means of the heat exchanger.
At least part of the cooling means of the heat exchanger is positioned inside the evaporation chamber, so as to be able to be cooled by the water in liquid form contained in the evaporation chamber.
The cooling means of the heat exchanger including a closed evaporation/condensation circuit, in which a working fluid can circulate in a closed loop, and which comprises an evaporator for said working fluid and a condenser for said working fluid; the evaporator allows the condensation of water vapor coming from the evaporation chamber.
Said water supply means make it possible to cool the working fluid during its passage in said condenser, with the water in liquid form pumped in a natural environment, and make it possible to supply the evaporation chamber with said water in liquid form after it is heated by the working fluid in the condenser.
The evaporator is positioned outside the evaporation chamber and the condenser is positioned inside the evaporation chamber, so as to be able to be submerged in the water in liquid form contained in the evaporation chamber.
Said heat exchanger constitutes an electricity production system that further makes it possible to recover the energy from the condensation of the water vapor coming from the evaporation chamber (10), and to convert it into electricity.
Said heat exchanger includes a turbine, which is mounted between the evaporator and the condenser, and which is able to be actuated by the working fluid in vapor state, so as to produce electricity.
The heat exchanger is designed to carry out a Kalina cycle, an Uehara cycle or a Rankine cycle, or a cycle derived from one or another of these cycles.
The cooling means of the heat exchanger include a cooling circuit, which is designed to be in contact with the water vapor coming from the evaporation chamber, and in which a heat transfer liquid circulates, and in which said water supply means make it possible to introduce and circulate said water in liquid form pumped in a natural environment in said cooling circuit, said water pumped in a natural environment serving as heat transfer liquid in the cooling circuit, and make it possible to supply the evaporation chamber with said water in liquid form coming from the cooling circuit after it has been heated by the water vapor coming from the evaporation chamber.
The gas supply means include a compressor, which is positioned between the evaporation chamber (10) and the heat exchanger (3/3′), and which makes it possible to suction gas and water vapor inside the evaporation chamber and supply the heat exchanger with gas and water vapor coming from the evaporation chamber; the evaporation chamber includes an intake opening through which, when the compressor is operating, gas is suctioned and injected into the water in liquid form contained in the evaporation chamber.
Said compressor makes it possible to create a vacuum inside the evaporation chamber so as to allow an evaporation of the water contained in the evaporation chamber at a temperature below 100° C., preferably below 60° C., and still more preferably below 25° C.
The intake opening of the evaporation chamber is an air intake communicating with the open air, by which air is injected into the water in liquid form contained in the evaporation chamber.
The intake opening of the evaporation chamber, by which gas is injected into the water in liquid form contained in the evaporation chamber, is equipped with a valve for controlling the flow rate of the gas.
The compressor makes it possible to heat the gas and the water vapor when they pass through the compressor.
The gas supply means include a compressor, an intake tubing for a gas in the compressor and an outlet tubing, which allows the injection of the gas delivered by the compressor into the water in liquid form contained in the evaporation chamber.
The gas supply means make it possible to automatically regulate the supply flow rate of the gas entering the water in liquid form contained in the evaporation chamber.
The gas supply means make it possible to recycle the gas coming from the evaporation chamber by reinjecting all or part of it into the water in liquid form contained in the evaporation chamber.
The water supply means make it possible to supply the evaporation chamber with water at a temperature above the temperature of the water discharged in liquid form from the evaporation chamber.
The water supply means are suitable for automatically regulating the water flow rate entering the evaporation chamber so as to maintain the evaporation of the water in the evaporation chamber.
The gas injected into the water in liquid form contained in the evaporation chamber is air or an air-based mixture.
The gas introduced into the water comprises an inert gas, and in particular helium.
The gas supply means allow the evaporation of the water contained in the chamber at an evaporation temperature below the boiling temperature of said water.
The facility is designed to evaporate a volume of liquid water at an evaporation temperature below 100° C., preferably below 60° C., and still more preferably below 25° C.
The gas supply means make it possible to inject air into the water in liquid form contained in the evaporation chamber by withdrawing all or part of that air from the ambient air outside the chamber.

The invention also relates to a method for treating water in liquid form, by evaporation/condensation, in which only part of the water in liquid form contained in an evaporation chamber of the evaporation device is evaporated in that evaporation chamber, and the water vapor coming from the evaporation chamber is condensed using a heat exchanger, in which a gas is injected into the water in liquid form contained in the evaporation chamber, so as to form gas bubbles in that water, in which water in liquid form is pumped in a natural environment, and in particular seawater, lake water or water from a stream, or groundwater, said water in liquid form pumped in a natural environment is sent through said cooling means or placed in contact with said cooling means, so as to allow the cooling of the water vapor coming from the evaporation chamber, and the evaporation chamber is supplied with that water in liquid form after that water in liquid form has been heated while having traversed or been placed in contact with said cooling means, wherein part of the water in liquid form contained in the evaporation chamber is discharged so as, in combination with the supply of water of the evaporation chamber, to renew the water in liquid form contained in the evaporation chamber such that the temperature of the water in liquid form contained in the chamber is kept at a sufficient temperature to maintain the evaporation of part of the water contained in the evaporation chamber.

More particularly, the method according to the invention may include the following additional and optional features, considered alone or in combination with one another:

The water contained in the evaporation chamber is not heated using an additional heating means.
The water is not heated before it is injected into the evaporation chamber using an additional heating means positioned between the cooling means and the evaporation chamber.
Said cooling means of the heat exchanger are positioned outside the evaporation chamber, this water in liquid form pumped in a natural environment is sent through the cooling means of said heat exchanger, and this water is injected in the evaporation chamber, after it has been heated during its passage in the cooling means of the exchanger.
At least part of the cooling means of the heat exchanger is positioned inside the evaporation chamber, and the water in liquid form, pumped in a natural environment, is injected into the evaporation chamber, such that said part of the cooling means of the heat exchanger positioned inside the evaporation chamber is submerged in the water in liquid form contained in the evaporation chamber.
The cooling means of said heat exchanger include a closed circuit, which contains a working fluid, and which comprises an evaporator of said working fluid and a condenser of said working fluid; the water vapor coming from the evaporation chamber is condensed by bringing it into contact with the evaporator; said working fluid is circulated in said closed circuit, so as to evaporate the working fluid during its passage in the evaporator and condense said working fluid during its passage in the condenser; said working fluid is cooled in said condenser with the water in liquid form pumped in a natural environment.
The evaporation chamber is supplied with said water in liquid form pumped in a natural environment, after it has been heated by the working fluid.
Electricity is produced by recovering at least part of the condensation energy of said water vapor coming from the evaporation chamber.
Before the passage of the working fluid in the condenser, the working fluid is used to rotate at least one electric turbine.
The water vapor coming from the evaporation chamber is condensed by placing it in contact with the cooling circuit of the cooling means of the heat exchanger; said water in liquid form that is pumped in a natural environment, and which serves as heat transfer fluid for said cooling circuit, is circulated in said cooling circuit, and the evaporation chamber is supplied with said water in liquid form coming from the cooling circuit after it has been heated by the water vapor coming from the evaporation chamber.
The evaporation chamber is at a pressure greater than or equal to the atmospheric pressure.
The evaporation chamber is placed under a vacuum.
The pressure in the evaporation chamber above the liquid is regulated automatically.
The flow rate of gas entering the water in liquid form contained in the evaporation chamber is regulated automatically.
Part of the water in liquid form contained in the evaporation chamber is continually replaced with water at a temperature higher than the temperature of the water that is discharged outside the evaporation chamber.
The flow rate of liquid entering the evaporation chamber is regulated automatically.
The gas injected into the liquid is air or an air-based gaseous mixture.
The gas introduced into the water in liquid form comprises an inert gas, and in particular helium.
Part of the water in liquid form contained in the evaporation chamber is evaporated at an evaporation temperature below the boiling temperature of said water.
Part of the water in the evaporation chamber is evaporated at an evaporation temperature below 100° C., preferably below 60° C., and more preferably below 25° C.
The water resulting from the condensation of the water vapor is recovered.
At least part of the gas injected into the water in liquid form contained in the evaporation chamber is air withdrawn from the ambient environment.
At least part of the gas injected into the water in liquid form contained in the evaporation chamber is recycled by being reinjected into the liquid contained in the evaporation chamber.

The invention also relates to a use of the aforementioned facility or method:
to produce electricity from water pumped in a natural environment, and in particular seawater, lake water or water from a stream, or groundwater.
   or
to purify, and if necessary desalinate and/or clean, water pumped in a natural environment, and in particular seawater, lake water or water from a stream, or groundwater,
   or
cool and/or clean the gas injected into the water in liquid form contained in the evaporation chamber.

### BRIEF DESCRIPTION OF THE FIGURES

The features and advantages of the invention will appear more clearly upon reading the following detailed description of specific alternative embodiments of the invention, the specific alternative embodiments being described as non-limiting and non-exhaustive examples of the invention, and in reference to the appended drawings, in which:

FIG. 1 diagrammatically shows an alternative embodiment of an evaporation device according to the invention.

FIG. 2 shows examples of operating curves of the device of FIG. 1, showing the evolution over time of the temperature of the water in the evaporation chamber for different initial volumes of water (2 l, 1 l, 2 l) and with different air flow rates (4 l/s; 6 l/s; 6 l/s).

FIG. 3 diagrammatically shows a first alternative embodiment of a facility according to the invention making it possible to produce electricity by evaporation/condensation of water pumped in a natural environment, and for example seawater.

FIG. 4 diagrammatically shows a second alternative embodiment of a facility according to the invention making it possible to produce electricity by evaporation/condensation of water pumped in a natural environment, and for example seawater.

FIG. 5 diagrammatically shows a third alternative embodiment of a facility according to the invention making it possible to produce electricity by evaporation/condensation of water pumped in a natural environment, and for example seawater.

FIGS. 6 to 8 respectively diagrammatically show facilities for treating water pumped in a natural environment by evaporation/condensation, and for example for desalinating seawater, in which the water pumped in a natural environment serves as heat transfer fluid in a cooling circuit used to condense water vapor coming from the evaporation chamber of the facility.

FIG. 9 diagrammatically shows a third alternative embodiment of a facility according to the invention making it possible to produce electricity by evaporation/condensation of water pumped in a natural environment, and for example seawater.

### DETAILED DESCRIPTION OF THE INVENTION

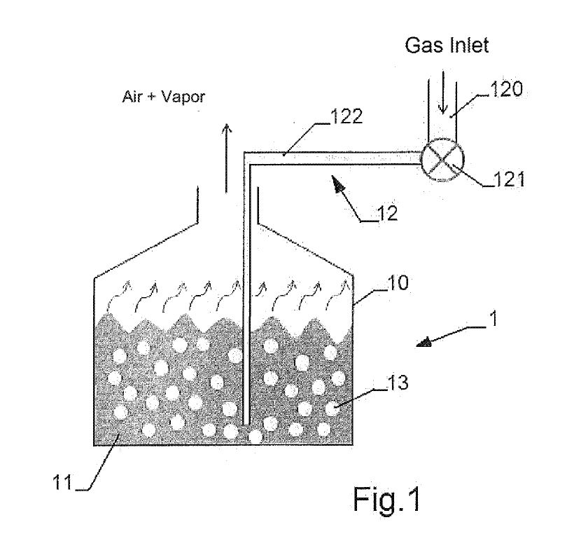

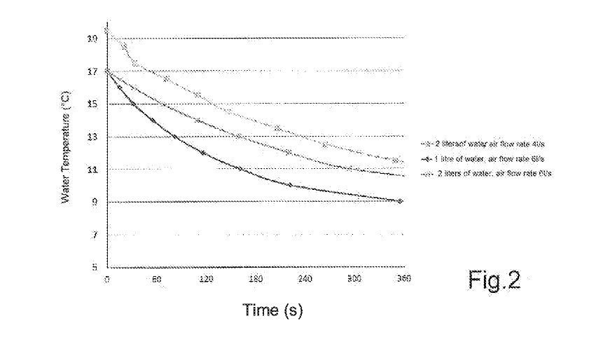

### FIGS. 1 and 2

FIG. 1 diagrammatically shows an example experimental evaporation device 1.

This device 1 includes:
an evaporation chamber 10 containing an initial volume of liquid 11 to be evaporated, and for example a volume of water.
supply means 12 making it possible to inject a gas, and for example air, into the liquid 11, so as to form gas bubbles 13 in the liquid.

The supply means 12 more particularly include a compressor 121, an intake duct 120 making it possible to supply the compressor 121 with ambient air, and an outlet duct 122, connected at one end to the outlet of the compressor 121, and having its other end submerged in the liquid 11, such that the air produced by the compressor 121 is injected into the liquid 11, near the bottom of the chamber 10.

The passage of a gas, such as air, through the liquid 11 causes forced boiling at a low temperature (in the case at hand, at ambient temperature), which makes it possible to improve the evaporation yield. This can be explained by the fact that the gas bubbles 13, which are created in a forced manner in the liquid by the gas, become charged with vapor (water vapor if the liquid 11 is water), while withdrawing latent heat Lᵥ from the liquid 11 and thus cooling the liquid in the chamber 10. Under the effect of the buoyancy, the bubbles 13 of gas charged with vapor rise increasingly quickly to burst on the surface of the water.

It should be noted that the gas may simply be air or any other gas, and for example, non-limitingly and non-exhaustively, an air-based gaseous mixture, or an inert gas, and in particular helium.

The device of FIG. 1 was tested under the following conditions:
Plastic chamber 10 containing an initial volume of water 11 at a temperature of 19.5° C. for the curve with an air flow rate of 4 l/s and 17° C. for the other two curves with an air flow rate of 6 l/s.
Temperature of the air jet leaving the compressor 121: 17° C.
Pressure of the air jet leaving the compressor 121: 2 bars
Flow rate of the air jet leaving the compressor 121: modifiable
Ambient temperature: 20.3° C.

FIG. 2 shows the evolution over time of the temperature of the water in the chamber 10 for different initial volumes of water (2 l; 1 l; 2 l) and with different air flow rates (4 l/s; 6 l/s; 6 l/s).

The curves of FIG. 2 show that the more the gas flow rate increases, the more quickly the temperature of the liquid in the chamber 10 drops. This temperature drop corresponds to the evaporation of a certain quantity of liquid. By controlling the gas flow rate at the inlet of the chamber, one thus acts on the evaporation speed of the liquid and the quantity of vapor produced over time.

Thus, the injection of a gas, and in particular air, into the liquid 11 contained in the evaporation chamber 10 advantageously makes it possible to create gas bubbles 13, and more particularly air bubbles, which allow the acceleration of the evaporation.

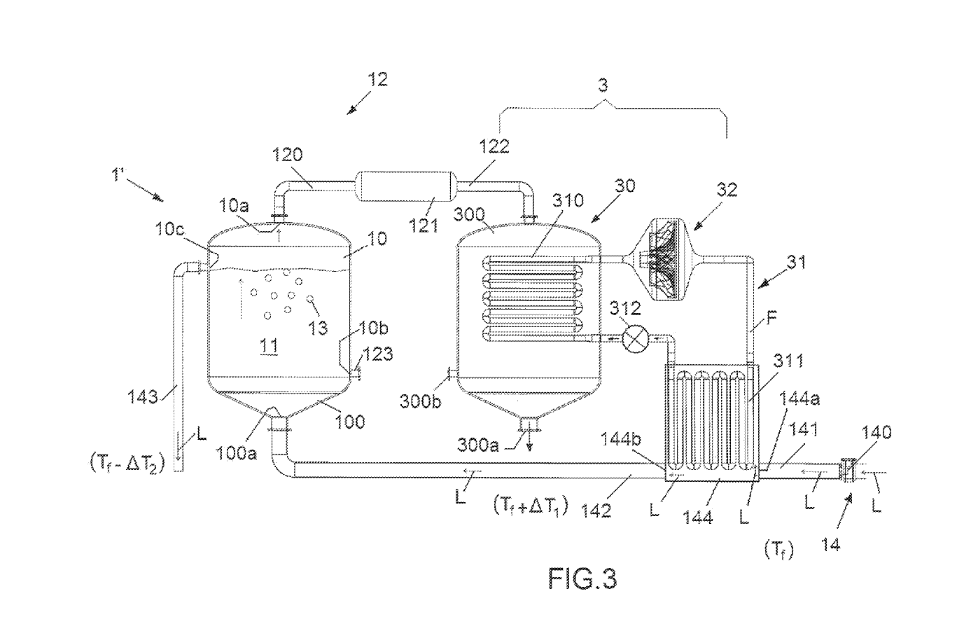

### FIG. 3: Electricity Production—1st Alternative

FIG. 3 shows an alternative embodiment of a facility according to the invention, and which makes it possible to produce electricity from the conversion of thermal energy from water, pumped in liquid form in a natural environment, and for example seawater, lake water or water from a stream, or water from an underground natural source.

This facility includes an evaporation device 1° by forced boiling, connected to a heat exchanger 3, which, in this alternative, more particularly allows the production of electricity from the condensation of the water vapor coming from the evaporation device 1′.

The evaporation device 1′ includes an evaporation chamber 10 intended to contain water 11, which has been pumped in liquid form in a natural environment.

This evaporation chamber 10 includes:
in its lower part, an air intake opening 10b that communicates with the open air outside the chamber,
in its upper part, an opening 10a that allows the discharge of the air and water vapor.

This evaporation chamber 10 includes a bottom 100 in which an opening 100a is arranged to supply it with water pumped in liquid form in a natural environment.

In the upper part, the evaporation chamber 10 also includes an opening 10c for discharging liquid water 11 contained in the chamber.

The heat exchanger 3 for producing electricity makes it possible to carry out a closed thermodynamic cycle, of the Rankine cycle type.

It includes a condensation unit 30, comprising a condensation chamber 300. which communicates with the discharge opening 10a of the evaporation chamber 10, and which allows the condensation of water vapor coming from the evaporation chamber 10.

The recovery of at least part of the condensation energy of the water vapor and its conversion into electricity are done by an energy conversion system of the Rankine type, which includes a closed circuit 31 in which a heat transfer working fluid circulates in a closed loop. This closed circuit 31 comprises an evaporator 310 for said working fluid (cold source of the Rankine cycle), which has a serpentine shape, and which is positioned in said condensation chamber 300, and a condenser 311 for said working fluid (hot source of the Rankine cycle), which has a serpentine shape, and which is positioned outside the condensation chamber 300. In a manner known itself, a compressor 312 is further inserted on the journey of the working fluid between the outlet of the condenser 311 and the inlet of the evaporator 310.

The heat exchanger 3 also comprises a turbine 32, which makes it possible to produce electricity using the working fluid F, and which is mounted on the journey of the working fluid, between the evaporator 310 of the working fluid and the condenser 311 of the working fluid.

The working fluid F is for example a mixture of water and ammonia.

The facility also includes supply means 12 allowing the forced injection of air into the water 11 contained in the enclosure 10.

These supply means 12 include a compressor 121 whereof the intake is connected to the discharge opening 10a of the evaporation chamber 10 by a duct 120, and the outlet of which is connected to an inlet of the condensation chamber 300 by a duct 122, and an air flow rate control valve 123 that is mounted on the intake opening 10b of the evaporation chamber 10.

More particularly, a filter (not shown) can be mounted at the outlet of the evaporation chamber 10, and upstream from the compressor 121, in order to avoid dirtying of the facility downstream from the evaporation device 1′.

The facility also includes water supply means 14, including a hydraulic pump 140, which makes it possible to pump water L in liquid form in a natural environment, for example seawater, lake water, water from a stream, or groundwater.

This hydraulic pump 140 is connected at its outlet to one end of a water supply duct 141. The other end of the water supply duct 141 is connected to the intake opening 144a of a cooling circuit 144, which is in contact with the condenser 311, and which makes it possible to cool the working fluid F circulating in the condenser 311. The discharge opening 144b of this cooling circuit 144 is connected to one end of a duct 142, which is connected at its other end to the opening 100a in the bottom 100 of the evaporation chamber 10.

The facility also includes a vertical discharge duct 143 that is connected to the opening 10c of the evaporation chamber, and which allows the discharge by gravity of part of the water 11 contained in the chamber 10.

The outlet 143a of this discharge duct 143, which is situated below the evaporation chamber 10, is for example, but not necessarily, submerged in the same natural water source (sea, ocean, lake, stream, etc.) as that in which the hydraulic pump 140 pumps water.

During operation, the hydraulic pump 140 is used to pump cold water L in liquid form at a temperature Tf in a natural environment, and in particular seawater, lake water or water from a stream, or groundwater; this water pumped in a natural environment is circulated in the cooling circuit 144, which makes it possible to cool the condenser 311, and to condense the heat transfer fluid F during its passage in the condenser 311. This water L is thus reheated as it passes in the cooling circuit 144.

This water L in liquid form and reheated to a temperature Tf+ΔT1 is then reintroduced into the evaporation chamber 10, through the intake opening 100a in the bottom 100 of the chamber 10, which makes it possible to renew and reheat the water in liquid form contained in this chamber 10.

When the water level in the evaporation chamber 10 is sufficient, part of the water contained in the chamber 10 is automatically discharged through the opening 10c and through the duct 143. The temperature (Tf+ΔT1) of the water in liquid form entering the evaporation chamber 10 is higher than the temperature (Tf−ΔT2) of the water in liquid form leaving the evaporation chamber 10 through the opening 10c. The water contained in the evaporation chamber is thus continuously renewed, and the temperature of the water in liquid form L contained in the chamber 10 is constantly kept at a sufficient temperature to maintain the evaporation of only part of the water contained in 10 the evaporation chamber, without it being necessary to heat the water in the chamber 10 using an additional heating means or to heat the water before it is injected into the chamber 10 by an additional heating means. “Additional heating means” refers to a heating means using an energy source outside the system, i.e., an energy source other than the energy coming from the water pumped in a natural environment, and for example a solar or electrical energy source.

The flow rate of the pump 140 is adjusted or regulated automatically, so as to continuously supply a sufficient quantity of thermal energy to keep the volume of water 11 in the chamber 10 at a high enough temperature for the evaporation phenomenon not to stop.

This flow rate of the pump 140 may be fixed or can advantageously be regulated automatically, for example from a liquid level detection in the chamber 10, in order to keep a minimum liquid level in the chamber over time, and/or for example from a detection of the liquid temperature 11 in the chamber 10, so as to keep the temperature of the liquid above a minimum temperature threshold conditioning the evaporation of the liquid over time.

In parallel, the compressor 121 operates and aspirates gas (in the case at hand, air) and water vapor in the upper part of the evaporation chamber 10, and creates a vacuum in the evaporation chamber 10 above the water level. This vacuum allows an aspiration of the air from outside the evaporation chamber through the valve 123 and the intake opening 10b of the chamber 10, and thus allows the forced injection of air coming from outside the chamber 10 into the volume of liquid water 11 contained in the chamber 10.

Comparably to what was previously described, this air forms air bubbles 13 (forced boiling) in the liquid water 11 that rise to the surface of the water and favor the evaporation of the water.

By adjusting or regulating the air flow rate entering the chamber 10 using the air flow rate control valve 123, the quantity of vapor produced over time is advantageously controlled.

The vacuum inside the chamber created by the compressor 121 and this forced boiling of the liquid water in the chamber 10 advantageously allow the production of water vapor with water at a low temperature, and for example with water at ambient temperature (Tf+ΔT1 for example comprised between 15° C. and 60° C.).

The air and the water vapor produced in the upper part of the evaporation chamber 10 are aspirated by the compressor 121, and are discharged by the compressor 121 into the condensation chamber 300, while having been heated by several degrees Celsius in the compressor 121.

The water vapor is condensed in the chamber 300 in contact with the evaporator 310 and cedes part of the calories to the working fluid F, which reheats and evaporates the working fluid F in the evaporator 310.

This working fluid F in vapor form makes it possible to rotate the turbine 32 that produces the electricity.

Once it has passed through the turbine 32, the working fluid F in vapor form is cooled in the condenser 311, then is recirculated toward the evaporator 310 by the compressor 312 inserted between the outlet of the condenser 311 and the inlet of the evaporator 310.

The water coming from the condensation of the water vapor in the chamber 300 is collected in the lower part of the chamber 300 and is discharged through the outlet 300a. The dry air after condensation is discharged from the condensation chamber 300 through an air outlet 300b.

When the hydraulic pump 140 withdraws saltwater (water taken from the sea or an ocean), the water coming from the condensation of the water vapor in the chamber 300 and collected in the lower part of the chamber 300 is fresh water, the facility thus making it possible, in addition to producing electricity, to produce fresh water by desalinating seawater. This fresh water can advantageously be recovered while being discharged from the condensation chamber 300 into a freshwater recovery circuit.

Additionally, regarding saltwater or fresh water taken from a natural environment, and which may contain pollutants, the evaporation/condensation of this water in the facility makes it possible to recover, at the outlet 300a of the evaporation chamber 300, cleaned purified water.

The forced injection of air into the evaporation chamber 10 advantageously makes it possible to generate water vapor at a low temperature (for example, at a temperature below 20° C.), without it being necessary to create a vacuum in the evaporation chamber 10. As an example, the vacuum created by the compressor 121 inside the evaporation chamber above the water level can for example be comprised between 0.1 bars and 0.5 bars.

This low-temperature vapor advantageously allows a more effective heat transfer by condensation, and consequently allows the implementation of a source (working fluid in the evaporator 310) that is less cold, to recover, by condensation, the energy stored in the vapor in order to convert it into electricity. It is therefore no longer necessary, unlike the traditional OTEC systems, to pump very cold water, and in particular seawater, at very great depths to cool the condenser 311, but this less-cold water (Tf for example comprised between 15° C. and 30° C.) can advantageously be pumped near the surface, and the energy conversion yields are improved.

The use of water vapor with forced boiling also makes it possible to reduce the need, in terms of structure and number, for pumps (the OTEC 100-MW systems currently require pumps with a cumulative flow rate of 111 m³/s to pump the hot seawater). In the facility of FIG. 3, the water pump 140 can have a relatively low flow rate in comparison.

The invention thus makes it possible to extract thermal energy from water in the natural environment, and in particular from seawater, with a lower energy consumption than the traditional OTEC systems.

The performance of the facility according to the invention depends on the temperature of the water that is pumped in a natural environment by the water pump 140. The performance of the facility according to the invention can be improved by increasing the temperature of the air injected into the liquid 11, since this hot air will cede its excess energy to the water vapor.

In one alternative of the invention, the walls of the evaporation chamber 10 can also be heated with an additional heating system.

In another alternative, the air injected into the chamber 10 can be replaced by another gas, and for example an air-based gaseous mixture, or an inert gas, and more particularly helium.

The facility of FIG. 3 can also be modified so as to implement a closed thermodynamic cycle of the Kalina cycle or Uehara cycle type, or derived from one and/or the other of these cycles, the water pumped in a natural environment also being used to cool a working fluid used in this closed thermodynamic cycle.

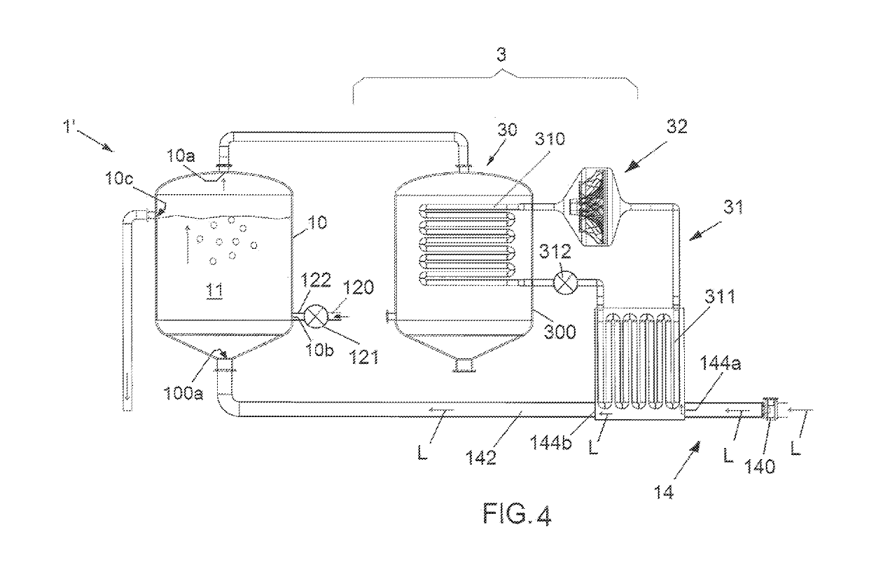

### FIG. 4: Electricity Production—2^{nd} Alternative

In another alternative illustrated in FIG. 4, the gas (in the case at hand, air withdrawn from the ambient environment) is injected into the chamber 10 in the same way as for FIG. 1, i.e., by using a compressor 121 that makes it possible to blow (and no longer suction) that gas in the volume of liquid 11 contained in the chamber 10. In this case, the discharge opening 10a of the evaporation chamber 10 can also be directly connected to the inlet of the condensation chamber 300 by a duct, or any other equivalent means, making it possible to place the upper part of the evaporation chamber 10 in communication with the condensation chamber 30. In this alternative, the evaporation chamber 10, above the water level 11, is at the atmospheric pressure.

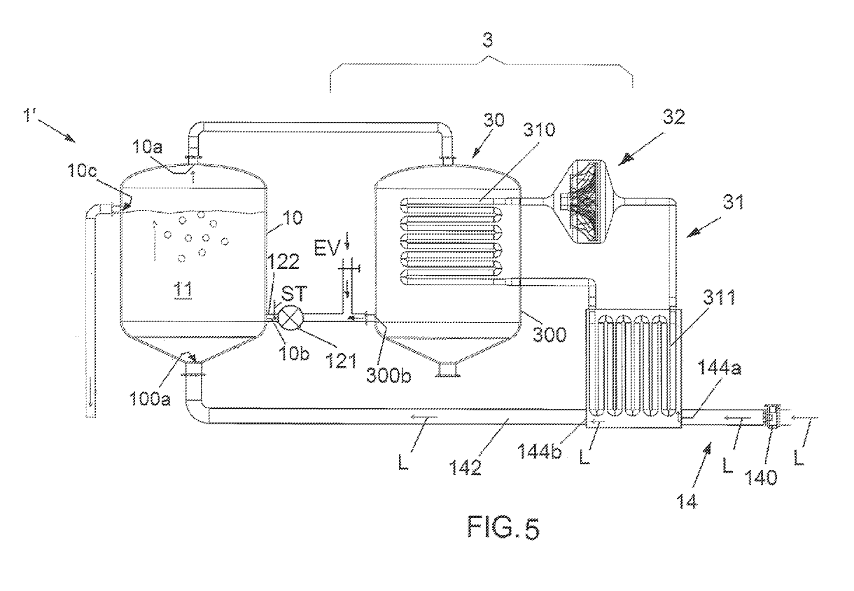

### FIG. 5: Electricity Production—3^{rd} Alternative

The facility can work in a closed circuit as illustrated in FIG. 5 by recycling, via the compressor 121, the dry air coming from the condensation system 30. In this FIG. 4, a solenoid valve EV is mounted on the intake tubing 120.

This modification makes it possible to reduce the electricity consumption of the compressor(s) 121. Indeed, the use of a compressor in a closed circuit requires less energy, since the same air is used continuously for the operation of the system.

One or several temperature sensors ST can be positioned within the air circulation circuit, in order to control the working air temperature and automatically steer the air intake solenoid valve EV, if it proves necessary to bring ambient air into the circuit in order to increase the temperature or completely change the working air.

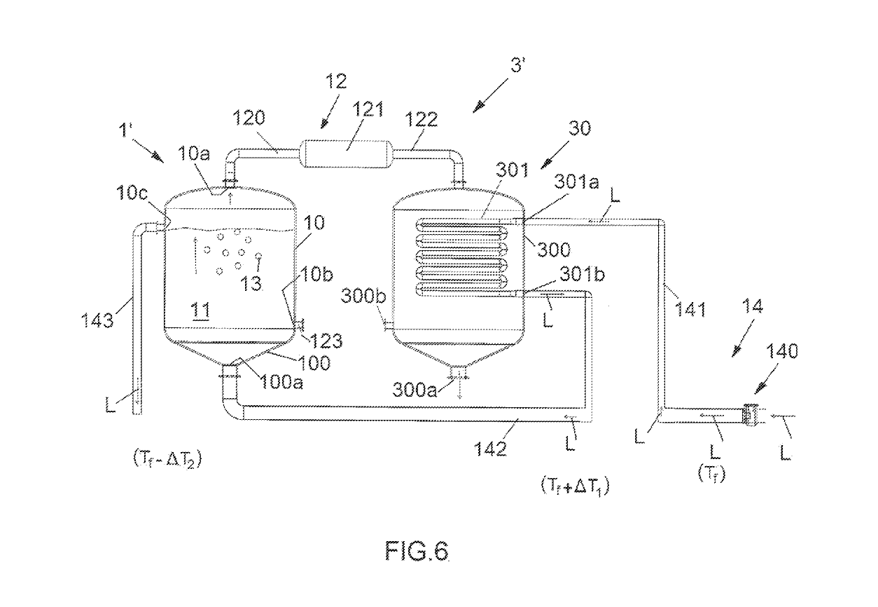

### FIG. 6: Facility For Treating Water Withdrawn From a Natural Environment by Evaporation/Condensation

FIG. 6 shows a facility for treating water withdrawn from a natural environment by evaporation/condensation, similar to the facility of FIG. 3 previously described inasmuch as it includes the following the same elements: evaporation device 1′; supply means 12 including a compressor 121 and an air flow rate control valve 123; water supply means 14 making it possible to pump water in liquid form in a natural environment.

This facility of FIG. 6 includes a heat exchanger 3′, which also allows the condensation of water vapor coming from the evaporation device 1, but which is different from the heat exchanger 3 of the facility of FIG. 3.

This heat exchanger 3′ includes a condensation unit 30, which includes a condensation chamber 300 communicating with the evaporation chamber 10 of the evaporation device 1′, and a cooling circuit 301 with a serpentine shape, which is positioned in the evaporation chamber 300, and in which a heat transfer liquid circulates.

In the facility of FIG. 6, the outlet of the hydraulic pump 140 is connected to the inlet 301a of the cooling circuit 301 by a duct 141, and the outlet 301 b of the cooling circuit 301 is connected to the intake opening 100a of the chamber 10 by a duct 142.

During operation, the hydraulic pump 140 makes it possible to pump water from a natural environment at a temperature Tf, to circulate this water pumped in a natural environment and serving as heat transfer liquid for the cooling circuit 301, in the cooling circuit 301. At the outlet of the cooling circuit 301, the water that has been heated (temperature Tf+ΔT1), following the heat exchanges resulting from the condensation in the chamber 300 of the water 20 vapor coming from the evaporation device 1′, is injected into the evaporation chamber 10 through the intake opening 100a.

The same advantages previously described for the facility of FIG. 3 are obtained with the facility of FIG. 6.

It is possible to modify this facility of FIG. 6 such that the gas that is injected into the volume of liquid water 11 contained in the evaporation chamber 10, through the intake opening 10b, is not air withdrawn from the ambient air, but is another gas.

More particularly, when this gas is a hot gas and/or a gas containing pollutants, the evaporation device 1′ in that case allows the cooling of that gas and/or the dissolution in the liquid 11 of the pollutants contained in the gas. After passage in the liquid 11, the gas is cooled and/or cleaned.

This device may for example be used to cool and clean a gas coming from an incinerator and which may have a temperature of several hundred degrees, the passage of the gas in the liquid making it possible to block the spread of the pollutants into the atmosphere.

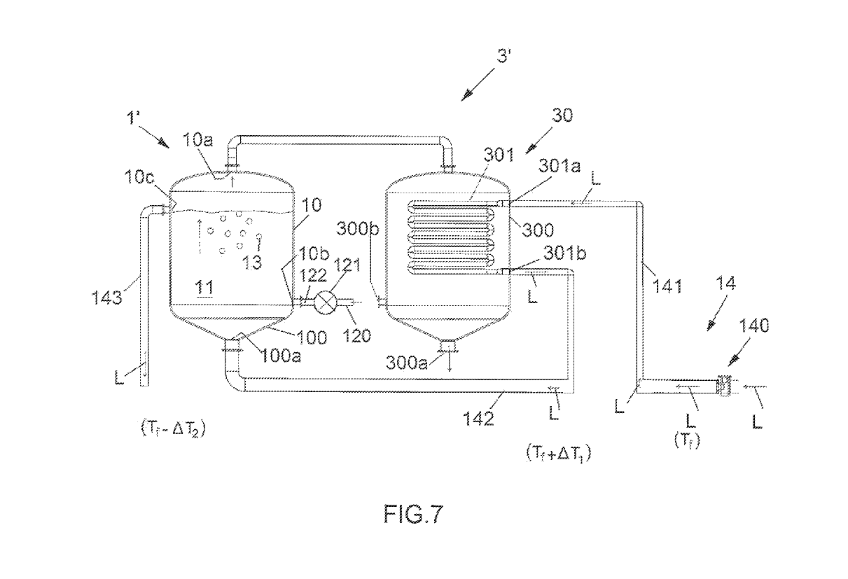

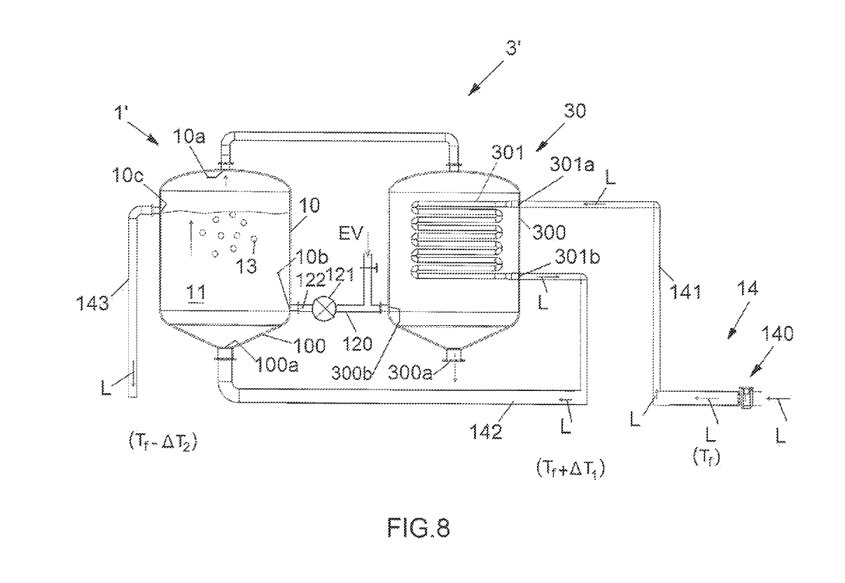

### FIGS. 7 and 8

FIG. 7 shows an alternative embodiment implementing a compressor 121 that makes it possible to blow (and no longer suction) a gas in the volume of liquid 11 contained in the chamber 10, comparably to the alternative of FIG. 4.

FIG. 8 shows an alternative embodiment working in a closed circuit similarly to the alternative of FIG. 5, i.e., by recycling, via the compressor 121, the dry air coming from the condensation unit 30.

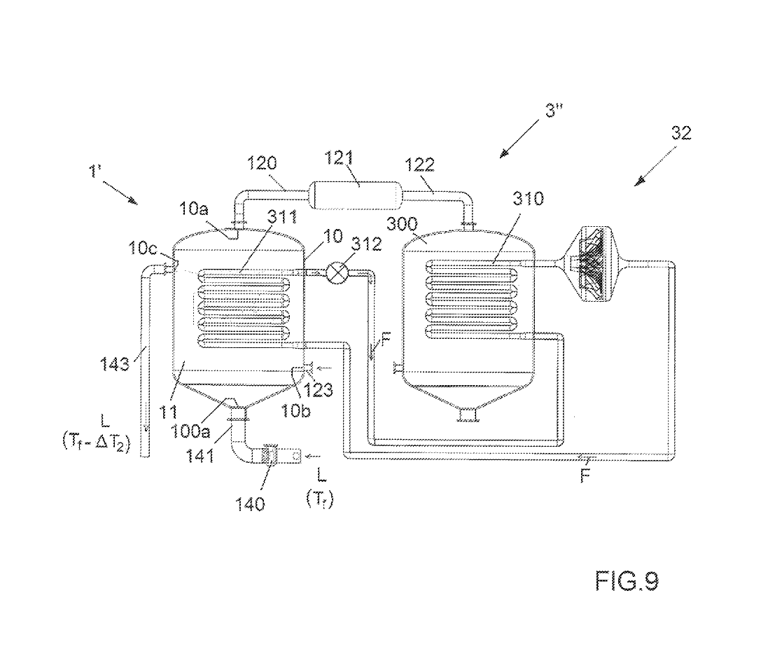

### FIG. 9

FIG. 9 shows another alternative embodiment, in which the evaporator 310 of the heat exchanger 3″ is positioned outside the evaporation chamber 10 and the condenser 311 is positioned inside the evaporation chamber 10, so as to be able to be submerged in the water in liquid form 11 contained in the evaporation chamber 10.

In this alternative, the pump 142 makes it possible to pump, in a natural environment, water L in liquid form at a temperature If. and to introduce that water directly into the evaporation chamber 10, such that the condenser 311 of the heat exchanger 3″ is submerged in the water in liquid form 11 contained in the evaporation chamber 10. When it passes in the condenser 311, the working fluid F is thus cooled by the water 11 contained the evaporation chamber 10, then is returned in liquid form by the compressor 312 into the evaporator 310 to allow the condensation of the water vapor coming from the evaporation chamber 10.

1. A facility for treating water pumped in a natural environment by evaporation and condensation, said facility including an evaporation device (1′), which comprises an evaporation chamber (10) intended to contain water (11) in liquid form, and allowing only a portion of the water contained in the evaporation chamber (10) to be evaporated, and gas supply means (12) making it possible to inject a gas into the water (11) in liquid form contained in the evaporation chamber (10), so as to form gas bubbles in that water, and a heat exchanger (3/3′/3″), which includes cooling means (300, 310, 311/300, 301) and which makes it possible at least to condense the water vapor coming from the evaporation chamber (10), said facility comprising water supply means (14), which make it possible to pump water in liquid form (L) in a natural environment, and in particular seawater, lake water or water from a stream, or groundwater, to send said water in liquid form pumped in a natural environment through said cooling means (300, 310, 311/300, 301) or place it in contact with said cooling means (300, 310, 311/300, 301), so as to allow the cooling of the water vapor coming from the evaporation chamber (10), and to supply the evaporation chamber (10) with that water in liquid form (L) pumped in a natural environment after that water in liquid form (L) has been heated while having traversed or been placed in contact with said cooling means (300, 310, 311/300, 301), wherein the evaporation chamber (10) includes means (10c; 143) for discharging part of the water in liquid form (1) contained in the evaporation chamber (10) which, in combination with the water supply means (14), allow a renewal of the water in liquid form (L) inside the evaporation chamber (10), such that the temperature of the water in liquid form (L) contained in the chamber (10) is kept at a sufficient temperature to maintain the evaporation of part of the water contained in the evaporation chamber (10).

2. The facility according to claim 1, wherein the evaporation chamber (10) has no additional means for heating the water contained in the evaporation chamber.

3. The facility according to claim 1, having no additional means for heating the water between the cooling means (300, 310, 311/300, 301) and the evaporation chamber (10).

4. The facility according to claim 1, wherein said cooling means (300, 310, 311/300, 301) of the heat exchanger (3/3′) are positioned outside the evaporation chamber (10), and the water supply means (14) make it possible to circulate said water in liquid form (L) pumped in a natural environment through said cooling means (300, 310, 311/300, 301) of the heat exchanger (3/3′), and make it possible to supply the evaporation chamber (10) with said water in liquid form (L) pumped in a natural environment, after it passes through the cooling means (300, 310, 311/300, 301) of the heat exchange (3/3′).

5. The facility according to claim 1, wherein at least part of the cooling means (311) of the heat exchanger (3″) is positioned inside the evaporation chamber (10), so as to be able to be cooled by the water in liquid form (11) contained in the evaporation chamber (10).

6. The facility according to claim 1, wherein the cooling means of the heat exchanger (3/3″) including a closed evaporation/condensation circuit (31), in which a working fluid (F) can circulate in a closed loop, and which comprises an evaporator (310) for said working fluid (F) and a condenser (311) for said working fluid (F), and wherein the evaporator (310) allows the condensation of water vapor coming from the evaporation chamber (10).

7. The facility according to claim 4, wherein said water supply means (14) make it possible to cool the working fluid (F) during its passage in said condenser (311), with the water (L) in liquid form pumped in a natural environment, and make it possible to supply the evaporation chamber (10) with said water in liquid form (L) after it is heated by the working fluid (F) in the condenser (311).

8. The facility according to claim 5, wherein the evaporator (310) is positioned outside the evaporation chamber (10) and the condenser (311) is positioned inside the evaporation chamber (10), so as to be able to be submerged in the water in liquid form (11) contained in the evaporation chamber (10).

9. The facility according to claim 1, which allows the production of electricity, and wherein said heat exchanger (3/3″) constitutes an electricity production system that further makes it possible to recover the energy from the condensation of the water vapor coming from the evaporation chamber (10), and to convert it into electricity.

10. The facility according to claim 9, wherein said heat exchanger (3/3″) includes a turbine (32), which is mounted between the evaporator (310) and the condenser (311), and which is able to be actuated by the working fluid (F) in vapor state, so as to produce electricity.

11. The facility according to claim 1, wherein the heat exchanger (3) is designed to carry out a Kalina cycle, an Uehara cycle or a Rankine cycle, or a cycle derived from one or another of these cycles.

12. The facility according to claim 2, wherein the cooling means of the heat exchanger (3′) include a cooling circuit (301), which is designed to be in contact with the water vapor coming from the evaporation chamber, and in which a heat transfer liquid circulates, and in which said water supply means (14) make it possible to introduce and circulate said water in liquid form (L) pumped in a natural environment in said cooling circuit (301), said water (L) pumped in a natural environment serving as heat transfer liquid in the cooling circuit (301), and make it possible to supply the evaporation chamber (10) with said water in liquid form (L) coming from the cooling circuit (301) after it has been heated by the water vapor coming from the evaporation chamber (10).

13. The facility according to claim 1, wherein the gas supply means (12) include a compressor (121), which is positioned between the evaporation chamber (10) and the heat exchanger (3/3′), and which makes it possible to suction gas and water vapor inside the evaporation chamber (10) and supply the heat exchanger (3/3′) with gas and water vapor coming from the evaporation chamber (10), and wherein the evaporation chamber includes an intake opening (10b) through which, when the compressor (121) is operating, gas is suctioned and injected into the water (11) in liquid form contained in the evaporation chamber (10).

14. The facility according to claim 13, wherein the compressor (121) makes it possible to create a vacuum inside the evaporation chamber (10) so as to allow an evaporation of the water contained in the evaporation chamber (10) at a temperature below 100° C., preferably below 60° C., and still more preferably below 25° C.

15. The facility according to claim 13, wherein the intake opening (10b) of the evaporation chamber (10) is an air intake communicating with the open air, by which air is injected into the water (11) in liquid form contained in the evaporation chamber (10).

16. The facility according to claim 13, wherein the intake opening (10b) of the evaporation chamber (10), by which gas is injected into the water (11) in liquid form contained in the evaporation chamber (10), is equipped with a valve (123) for controlling the flow rate of the gas.

17. The facility according to claim 13, wherein the compressor (121) makes it possible to heat the gas and the water vapor when they pass through the compressor.

18. The facility according to claim 1, wherein the gas supply means (12) include a compressor (121), an intake tubing (120) for a gas in the compressor (121) and an outlet tubing (122), which allows the injection of the gas delivered by the compressor (121) into the water (11) in liquid form contained in the evaporation chamber (10).

19. The facility according to claim 1, wherein the gas supply means (12) make it possible to automatically regulate the supply flow rate of the gas entering the water (11) in liquid form contained in the evaporation chamber (10).

20. The facility according to claim 1, wherein the gas supply means (12) make it possible to recycle the gas coming from the evaporation chamber (10) by reinjecting all or part of it into the water (11) in liquid form contained in the evaporation chamber (10).

21. The facility according to claim 1, wherein the water supply means (14) make it possible to supply the evaporation chamber (10) with water at a temperature (Tf+ΔT1 or Tf) above the temperature (Tf−ΔT2) of the water discharged in liquid form from the evaporation chamber (10).

22. The facility according to claim 1, wherein the water supply means (14) are suitable for automatically regulating the water flow rate entering the evaporation chamber (10) so as to maintain the evaporation of the water in the evaporation chamber (10).

23. The facility according to claim 1, wherein the gas injected into the water (11) in liquid form contained in the evaporation chamber (10) is air or an air-based mixture.

24. The facility according to claim 1, wherein the gas introduced into the water comprises an inert gas, and in particular helium.

25. The facility according to claim 1, wherein the gas supply means (12) allow the evaporation of the water (11) contained in the chamber at an evaporation temperature below the boiling temperature of said water.

26. The facility according to claim 1, designed to evaporate a volume of liquid water at an evaporation temperature below 100° C., preferably below 60° C., and still more preferably below 25° C.

27. The facility according to claim 1. wherein the gas supply means (12) make it possible to inject air into the water (11) in liquid form contained in the evaporation chamber (10) by withdrawing all or part of that air from the ambient air outside the chamber.

28-50. (canceled)

51. A use of the facility set out in claim 1 to produce electricity from water pumped in a natural environment, and in particular seawater, lake water or water from a stream, or groundwater; or to purify, and if necessary desalinate and/or clean, water pumped in a natural environment, and in particular seawater, lake water or water from a stream, or groundwater; or to cool and/or clean the gas injected into the water in liquid form contained in the evaporation chamber.

52. (canceled)

53. (cancelled)
